(19) United States
(12) Patent Application Publication
(10) Pub. No.: US 2006/0197014 A1
(43) Pub. Date: Sep. 7, 2006

(54) Cartridge type solid-state image pickup apparatus

(75) Inventor: Masafumi Inuiya, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/363,937

(22) Filed: Mar. 1, 2006

(30) Foreign Application Priority Data
Mar. 1, 2005 (JP) P.2005-055597
Mar. 1, 2005 (JP) P.2005-055605
Mar. 11, 2005 (JP) P.2005-069033
Mar. 17, 2005 (JP) P.2005-077037

(51) Int. Cl. H01J 5/02; G03B 17/26

(52) U.S. Cl. 250/239; 396/511

(57) ABSTRACT

Cartridge type solid-state image pickup apparatus, which is used to photograph a digital image while it is attached to a film camera instead of a film, comprises: a housing having a shape of a cartridge from which the film is drawn by a predetermined length; and a solid-state imaging element mounted on a part corresponding to the film, wherein the solid-state imaging element has a light-receiving surface of an aspect ratio horizontally greater than that of a rectangular range to be photographed.

### BACKGROUND OF THE INVENTION

1. Field of the Invention

The present invention relates to cartridge type solid-state image pickup apparatus attached to a silver salt film camera for photographing a digital image, and in particular to cartridge type solid-state image pickup apparatus attachable to various types and sizes of compact cameras and single-lens reflex cameras.

In particular, the present invention relates to cartridge type solid-state image pickup apparatus attachable to also a silver salt film camera that mounts a focal-plane shutter.

2. Description of the Related Art

FIG. 10 is a perspective view of related art cartridge type solid-state image pickup apparatus disclosed in JP-A-09-98326, JP-A-2000-184250 and JP-A-2003-234932. The related art cartridge type solid-state image pickup apparatus 1 comprises a housing 2 in the shape of a cartridge accommodating a silver salt film from which the film is drawn by a predetermined length such as 10 centimeters, the film-related part 3 of the housing 2 having a solid-state imaging element 4 attached thereto and the cartridge-related part 5 accommodating an electronic circuit and a battery power supply.

As shown in FIG. 11, the rear lid 6 of the film camera 5 is opened. Then, cartridge type solid-state image pickup apparatus 1 is attached into the film camera 5 so as to orient the solid-state imaging element 4 in the direction of a lens 7. Then the rear lid 6 is closed.

When the release button 8 of the film camera 5 is half-depressed and an S1 switch is turned on, the auto-focusing function and exposure function of the film camera 5 operate to determine a focus lens position, a diaphragm aperture quantity and a shutter speed. When the release button 8 is fully depressed and an S2 switch is turned on, the shutter is released. This causes a subject image photographed through the lens 7 to be imaged on the light-receiving surface of the solid-state imaging element 4 and causes digital image data to be captured from the solid-state imaging element 4 into the memory of the electronic circuit.

Various types of film cameras where cartridge type solid-state image pickup apparatus is attached are available, from small ones such as compact cameras to large-sized cameras such as single-lens reflex cameras. Different types and sizes of film cameras where cartridge type solid-state image pickup apparatus is attached results in different distances from the cartridge-accommodating position of a film camera to the imaging surface of a subject image obtained through the lens of the film camera.

As shown in FIG. 10, the related art cartridge type solid-state image pickup apparatus 1 has a problem that the distance t from the cartridge part 5 to the center of light-receiving surface of the solid-state imaging element 4 is fixed so that a single model of cartridge type solid-state image pickup apparatus 1 cannot be attached to various types of film cameras. Thus, it is necessary to manufacture cartridge type solid-state image pickup apparatus having a size suitable for each type of film cameras. This invites an increase in the manufacturing cost, which fails to provide a low-cost cartridge type solid-state image pickup apparatus.

FIG. 23 is a schematic cross-sectional view of a related art solid-state imaging element mounted on cartridge type solid-state image pickup apparatus showing cross sections corresponding to three pixels on the section through the line a-a in FIG. 10.

The related art solid-state imaging element 4 has photodiodes 511R, 511G and 511B formed on the surface of a semiconductor substrate 510. An electric charge transfer path 512 is formed across the photodiodes 511R, 511G and 511B. A transfer electrode 513 is formed on the electric charge transfer path 512. On the transfer electrode 513 is stacked a light-shielding film 514 that shields light and has apertures above the light-receiving surfaces of the photodiodes 511r, 511G and 511B. On the light-shielding film 14 is stacked a transparent insulation layer 515, on which a color filter 516 of red color (R), green color (G) and blue color (B) is stacked. On the color filter 516 is stacked a microlens 517.

Further, a protective cover glass 518, an optical low-pass filter 519, and an IR cutoff filter 520 are stacked in this order. The function of the cover glass 518 may be realized by the IR cutoff filter 520 or the optical low-pass filter 519.

The related art solid-state imaging element 4 has the photodiode 511R for detecting red color (R), the photodiode 511G for detecting green color (G), and the photodiode 511B for detecting blue color (B) formed at different positions. Unless a space frequency component above the Niquist frequency is cut off, color moiré is eminent in a photographed image, so that an optical low-pass filter 519 is an essential component.

The IR cutoff filter 520 is used to cut off the infrared component of a long wavelength from light incident on the solid-state imaging element 4. The photodiodes 511R, 511C, 511B provided on the semiconductor substrate 510 and constituting the pixels each has a higher sensitivity to the infrared region than visible light of R,G,B. The infrared light cannot be cutoff even when unnecessary visible light is cut off using the color filter 516. Thus, the IR cutoff filter 520 is an essential component in order to detect R, G and B that have undergone accurate color separation.

In a general digital camera, the IR cutoff filter 520 is provided on the lens system of the camera. The cartridge type solid-state image pickup apparatus uses the lens system of a silver salt film camera that does not mount an IR cutoff filter. It is thus necessary to provide the IR cutoff filter 520 in front of the solid-state imaging element 4.

The related art solid-state imaging element 4 is a CCD image sensor in the above discussion although an optical low-pass filter and an IR cutoff filter are essential to a CMOS image sensor.

The related art solid-state imaging element 4 mounted on cartridge type solid-state image pickup apparatus requires the IR cutoff filter 520 and the optical low-pass filter 519 as essential components. These components each has a considerable thickness of 3 to 5 mm, which contributes to the extended thickness of the filmpart 3 of the cartridge type solid-state image pickup apparatus.

Silver salt film cameras that mount cartridge type solid-state image pickup apparatus includes one mounting a focal-plane shutter such as a single-lens reflex camera. A focal-plane shutter is arranged immediately before a film and its front and rear curtains travel immediately before the film.

In case the film-related part of the cartridge type solid-state image pickup apparatus, that is, the film part 3 on which the solid-state imaging element is mounted is tick, it is impossible to even attach the cartridge type solid-state image pickup apparatus to a silver salt film camera mounting a focal-plane shutter. It is thus impossible to photograph a digital image by using a silver salt film camera of a high-performance single-lens reflex camera type.

In the case of a camera that allows lens replacement such as a single-lens reflex camera, the exit pupil position changes with the lens used. In case a small-sized short-focus lens is use, the exit pupil distance is reduced. The microlens 517 shown in FIG. 23 stacked on the surface of the solid-state imaging element is designed to show optimum shading with respect to a limited exit pupil distance, so that shading takes place when the when the lens is replace with a new one and the exit pupil position is changed.

A related art solid-state imaging element has a signal reading circuit such as an electric charge transfer circuit or a MOS transistor circuit mounted on a semiconductor substrate. Thus, the area of the light-receiving surfaces of photodiodes 511R, 511G, 511B is reduced. Without the microlens 517, the light usage efficiency is worsened.

Another object of the invention is to provide cartridge type solid-state image pickup apparatus that mounts a low-profile color solid-state imaging element and that suppresses shading after lens replacement, the cartridge type solid-state image pickup apparatus attachable to also a film camera mounting a focal-plane shutter.

### SUMMARY OF THE INVENTION

An object of the invention is to provide a low-cost cartridge type solid-state image pickup apparatus that may be attached to various types of film cameras.

Cartridge type solid-state image pickup apparatus according to a first aspect of the invention, which is used to photograph a digital image while it is attached to a film camera instead of a film, comprises: a housing having a shape of a cartridge from which the film is drawn by a predetermined length; and a solid-state imaging element mounted on a part corresponding to the film, the cartridge type solid-state image pickup apparatus being used to photograph a digital image while it is attached to a film camera instead of a film, wherein the solid-state imaging element has a light-receiving surface of an aspect ratio horizontally greater than that of a rectangular range to be photographed.

According to the first aspect of the invention, a solid-state imaging element having an extended light-receiving surface in horizontal direction is mounted. This configuration makes it possible to mount the solid-state imaging element into various types and sizes of film cameras and receive light on the light-receiving surface even when the distance from the imaging surface to the cartridge part is different. A single model of cartridge type solid-state image pickup apparatus supports various types of film cameras thereby reducing the manufacturing cost of the cartridge type solid-state image pickup apparatus.

Related art cartridge type solid-state image pickup apparatus is always turned on since it is accommodated in the camera 5 with a power switch on the housing 2 turned on. Thus, battery power is consumed even when photography is not made using the camera 5, which is disadvantageous for long-duration photography of digital images. Although the battery power is kept active by opening the rear lid 6 of the camera 5 and turning on/off the power switch, that will lead to loss of a photo opportunity.

An object of the invention is to provide cartridge type solid-state image pickup apparatus that can keep the battery power active for a long duration without losing a photo opportunity.

Cartridge type solid-state image pickup apparatus according to a second aspect of the invention, which is used to photograph a digital image while it is attached to a film camera instead of a film, comprises: a housing having a shape of a cartridge from which the film is drawn by a predetermined length; a solid-state imaging element mounted on a part corresponding to the film; an electronic circuit that drives the solid-state imaging element and processes data read from the solid-state imaging element, the electronic circuit being in a part corresponding to the cartridge; a battery power supply in the part corresponding to said cartridge; a controller that operates on power from the battery power supply; a switch section that feeds power of the battery power supply to the electronic circuit on receiving a power input command from the controller; and a camera attachment configured separately from the housing and connected to the controller via radio waves, the camera attachment comprising: a button attached on a release button of the film camera and pressed integrally with the release button; a sensor that senses a touch on the button; and a radio originating section that performs radio transmission of a detection signal to the controller when the touch is sensed so as to output the power input command to the switch section.

According to the second aspect of the invention, the battery power is input when the user attempts to depress a release button before photographing. When photographing action is stopped, the power save mode is automatically activated. This suppresses battery power consumption and allows photography of digital images for a long duration.

Cartridge type solid-state image pickup apparatus according to a third aspect of the invention, which is used to photograph a digital image while it is attached to a film camera instead of a film, comprises a housing having a shape of a cartridge from which the film is drawn by a predetermined length; and a solid-state imaging element mounted on a part corresponding to the film, wherein the housing comprises: a first housing that has a plate shape corresponding to a shape of the film and mounts the solid-state imaging element; and a second housing that has a cylinder shape corresponding to the cartridge to which the first housing is attached in a fashion that the first housing can be inserted therein and can be drawn therefrom for a predetermined distance.

According to the third aspect of the invention, the first housing mounting a solid-state imaging element is attached to the second housing as a cartridge part in a slidable fashion. When the cartridge type solid-state image pickup apparatus is attached to a large-sized film camera, the first housing is drawn from the second housing. When the cartridge type solid-state image pickup apparatus is attached to a small-sized film camera, the first housing is inserted into the second housing. In this way, it is possible to align the light-receiving surface of a solid-state imaging element with the image forming surface of each film camera. Thus, a single model of cartridge type solid-state image pickup apparatus supports various types and sizes of film cameras. This reduces the manufacturing cost of cartridge type solid-state image pickup apparatus.

Cartridge type solid-state image pickup apparatus, which is used to photograph a digital image while it is attached to a film camera instead of a film, comprises: a housing having a shape of a cartridge from which a film is drawn by a predetermined length; a solid-state imaging element mounted on a part corresponding to the film; and an electronic circuit that drives the solid-state imaging element and processes data read from the solid-state imaging element, the electronic circuit being in a part corresponding to the cartridge; a battery power supply being in a part corresponding to the cartridge; wherein the solid-state imaging element is a photoelectric conversion film stacked color solid-state imaging element comprising: a semiconductor substrate; and at least one layer of photoelectric conversion film for performing photoelectric conversion of green light on or above the semiconductor substrate.

In a fifth aspect of the invention, the photoelectric conversion film stacked color solid-state imaging element further comprises: a photoelectric conversion film for performing photoelectric conversion of red light; and a photoelectric conversion film for performing photoelectric conversion of blue light, on or above the semiconductor substrate.

In a sixth aspect of the invention, wherein the photoelectric conversion film stacked color solid-state imaging element further comprises: a first photodiode for receiving and performing photoelectric conversion of blue light; and a second photodiode for receiving and performing photoelectric conversion of red light in the semiconductor substrate.

In a seventh aspect of the invention, the first photodiode and the second photodiode are stacked in a depth direction of the semiconductor substrate.

In an eight aspect of the invention, an infrared light cutoff filter layer is integrally formed on the photoelectric conversion film stacked color solid-state imaging element.

According to the fourth to eight aspects of the invention, signals of multiple colors are detected by one pixel so that an optical low-pass filter may be done without. The result is a lower-profile design. Light is received by a photoelectric conversion film, which enlarges the light-receiving area and a microlens is no longer required. Thus, shading is suppressed even after lens replacement of a film camera.

### BRIEF DESCRIPTION OF THE DRAWINGS

FIG. 1 is rear perspective view of a film camera to which the cartridge type solid-state image pickup apparatus according to an embodiment of the invention is attached;

FIG. 2 is a circuit block diagram of the camera attachment shown in FIG. 1;

FIG. 3 is a front perspective view of the cartridge type solid-state image pickup apparatus according to the first embodiment of the invention;

FIG. 4 is a rear perspective view of the cartridge type solid-state image pickup apparatus shown in FIG. 3;

FIG. 5 is a functional block diagram of the cartridge type solid-state image pickup apparatus according to the first and second embodiments of the invention;

FIG. 6 is a flowchart showing the processing procedure of a power supply control program executed by the CPU shown in FIG. 5;

FIG. 7 is a flowchart showing the segmenting position calculation of photographed image data performed by the cartridge type solid-state image pickup apparatus shown in FIG. 3;

FIG. 8 illustrates the processing shown in FIG. 7;

FIG. 9 is a flowchart showing the photographed image data segmentation performed by the cartridge type solid-state image pickup apparatus shown in FIG. 3;

FIG. 10 is a front perspective view of related art cartridge type solid-state image pickup apparatus; and

FIG. 11 is a rear perspective view of the cartridge type solid-state image pickup apparatus shown in FIG. 10.

FIG. 12 is a front perspective view of the cartridge type solid-state image pickup apparatus according to the second embodiment of the invention;

FIG. 13 is a front perspective view of the cartridge type solid-state image pickup apparatus according to the third embodiment of the invention;

FIG. 14A shows the shortest configuration where the first housing of the cartridge type solid-state image pickup apparatus shown in FIG. 13 is pushed into the second housing;

FIG. 14B shows the longest configuration where the first housing is drawn from the second housing;

FIG. 15 is a rear perspective view of the cartridge type solid-state image pickup apparatus shown in FIG. 13;

FIG. 16 is a functional block diagram of the cartridge type solid-state image pickup apparatus according to the third embodiment of the invention;

FIG. 17 is a flowchart showing the position determination processing of a solid-state imaging element performed by the cartridge type solid-state image pickup apparatus shown in FIG. 13;

FIG. 18 is a schematic cross-sectional view of the unit cell of a solid-state imaging element to be mounted on the cartridge type solid-state image pickup apparatus according to the fourth embodiment of the invention;

FIG. 19A illustrates the chemical formula of Alq as an exemplary material of the photoelectric conversion film shown in FIG. 18;

FIG. 19B illustrates the chemical formula of a quinacridon compound as an exemplary material of the photoelectric conversion film shown in FIG. 18;

FIG. 20 is a schematic cross-sectional view of the unit cell of a solid-state imaging element according to the fifth embodiment of the invention;

FIG. 21 is a schematic cross-sectional view of the unit cell of a solid-state imaging element according to the sixth embodiment of the invention;

FIG. 22 is a schematic cross-sectional view of 1.5 unit cells of a solid-state imaging element to be mounted on the cartridge type solid-state image pickup apparatus according to the seventh embodiment of the invention; and

FIG. 23 is a schematic cross-sectional view of 3 unit cells of a solid-state imaging element to be mounted on related art cartridge type solid-state image pickup apparatus.

### DETAILED DESCRIPTION OF THE INVENTION

Embodiments of the invention will be described referring to drawings.

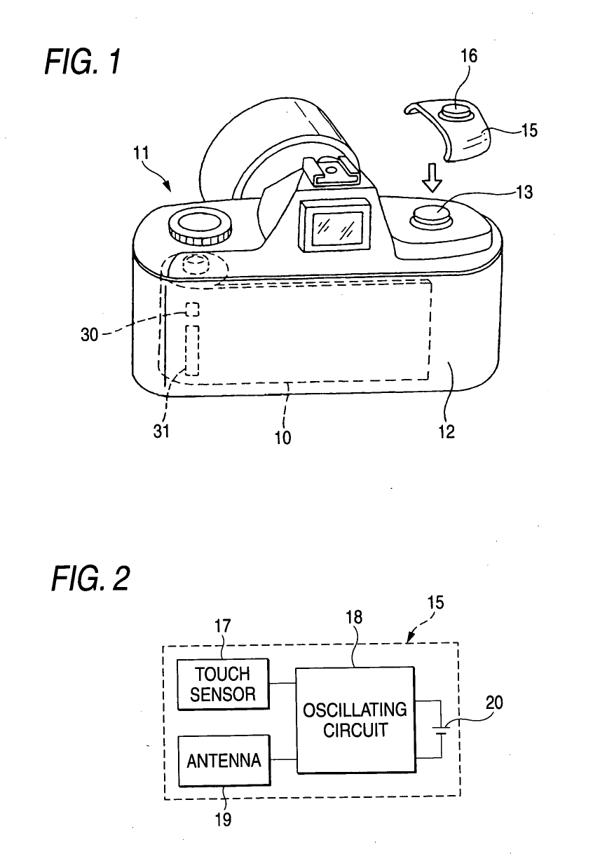

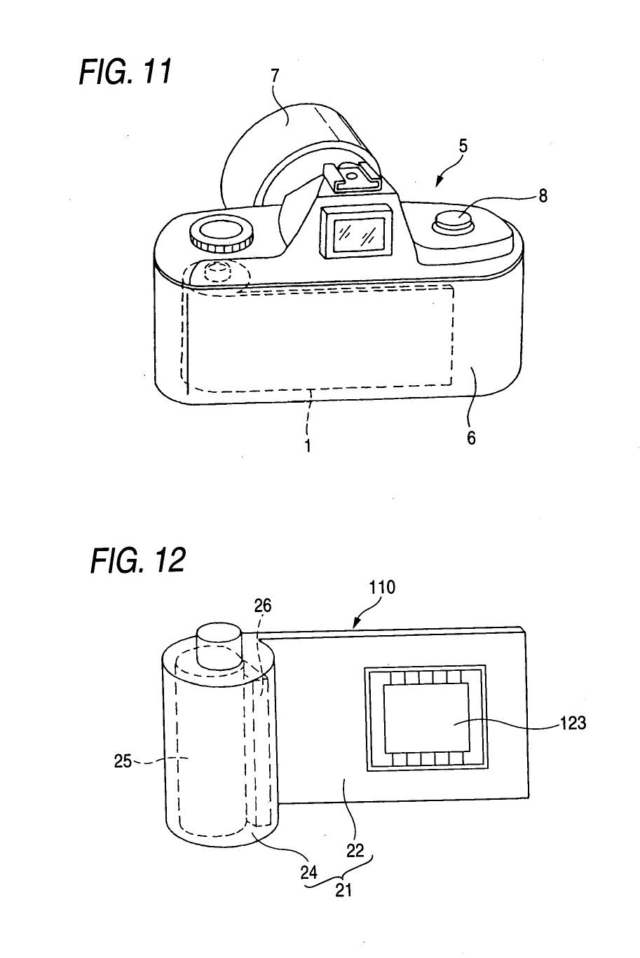

FIG. 1 illustrates a silver salt film camera to which cartridge type solid-state image pickup apparatus according to the invention is attached. Same as FIG. 11, the cartridge type solid-state image pickup apparatus 10 according to the invention is attached to a film camera 11 with a rear lid 12 open. In this embodiment, a camera attachment 15 is further provided that is detachably fitted to apart where the release button 13 of the film camera 11. The camera attachment 15 is provided with a button 16 covering the release button for a simultaneous push on the button and the release button 13.

FIG. 2 shows an internal circuit of the camera attachment 15. The camera attachment 15 comprises a touch sensor 17 for sensing a user's finger touching the button 16, an oscillating circuit (radio originating section) 18 for oscillating at a predetermined frequency when the touch sensor has sensed a touch non the button 16, an antenna for sending the output of the oscillating circuit 18 via radio waves, and a button battery 20 for supplying power to the oscillating circuit 18 and the touch sensor 17.

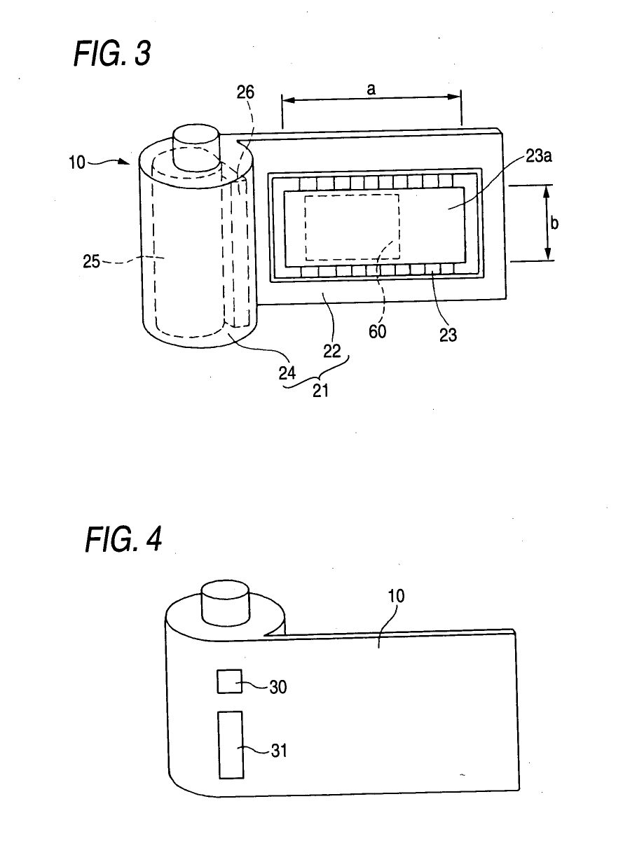

FIG. 3 is a front perspective view of the cartridge type solid-state image pickup apparatus 10 according to the first embodiment. To a film-related part 22 of the cartridge type solid-state image pickup apparatus 10 is attached a solid-state imaging element 23. In a film-related part 24 are accommodated a replaceable battery power supply 25 and an electronic circuit 26.

FIG. 12 is a front perspective view of the cartridge type solid-state image pickup apparatus 110 according to the second embodiment.

The solid-state imaging element 23 used in the first embodiment has a horizontally extended light-receiving surface 23a than that of an ordinary landscape photograph (the ratio of the horizontal length a to the vertical length b is a:b=3:2 for a 35 mm film) corresponding to the solid-state imaging element 123. The length b of the light-receiving surface of the solid-state imaging element 23 in vertical direction may be approximately the same as the exposure surface of a silver salt film in vertical direction; the horizontal length a shall be so that all imaging surfaces of film cameras of a variety of types and sizes will fall within the light-receiving surface 23a of the solid-state imaging element 23. Note that a rectangular frame 60 shown in the light-receiving surface 23a in FIG. 3 represents a range photographed using a 35 mm film.

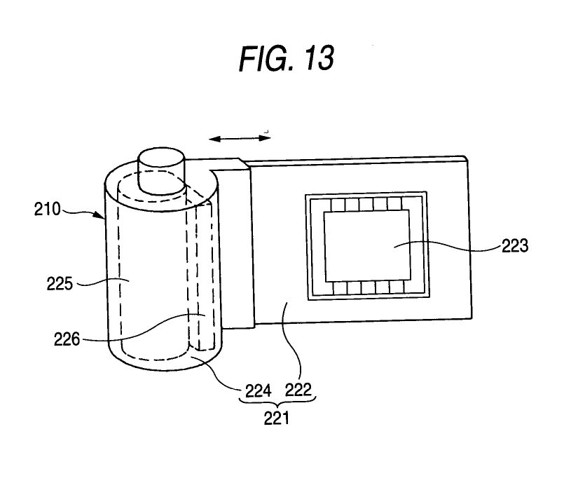

FIG. 13 is a front perspective view of cartridge type solid-state image pickup apparatus 210 according to the third embodiment. To the film-related part (first housing) 222 of the housing 221 of the cartridge type solid-state image pickup apparatus 210 is attached a solid-state imaging element 223. In the cartridge-related part (second housing) 224 are accommodated a replaceable battery poser supply 225 and an electronic circuit 226.

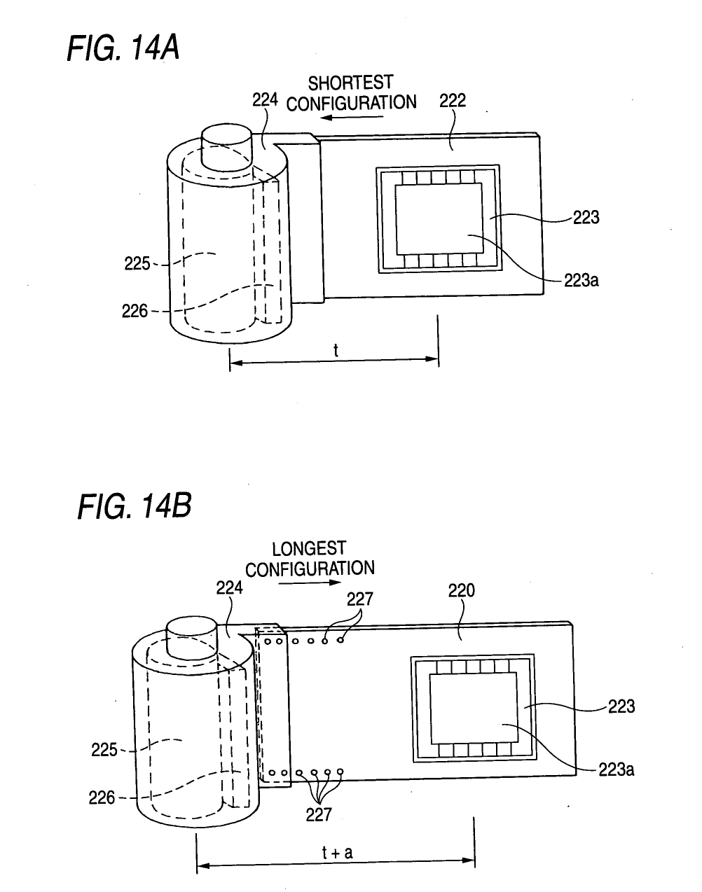

The first housing 222 is attached to the second housing 224 in a fashion that the first housing 222 can be inserted therein and can be drawn therefrom for a predetermined distance for example a maximum of 2 centimeters. FIG. 14A shows a state where the first housing 222 is fully inserted in the second housing 224, and FIG. 14B shows a state where the first housing 222 is fully drawn from the second housing 224.

Assuming that the distance between the center of the light-receiving surface of the solid-state imaging element 223 mounted on the first housing 222 and the center of the second housing 224 is t, the distance between the center of the light-receiving surface of the solid-state imaging element 223 and the center of the second housing 224 assumed when the first housing 222 is fully drawn from the second housing 222 is t+a (A=2 cm in the above example) .

At the joint of the second housing 224 and the first housing 222 to be inserted into the second housing 224 is provided a latch mechanism in steps of 2 mm so as to insert/draw the first housing 222 into/from the second housing 224 to fix the first housing 222 to the second housing 224. The first housing 222 cannot be completely removed from the second housing 224.

While the latch mechanism in the shown example includes protrusions 227 provided at intervals of 2 mm along the upper edge and lower edge of the joint part of the first housing 222 and holes (not shown) provided on the inner side of the joint part of the second housing 224, the holes fitted into the protrusions 227, any other latch mechanism may be used instead.

In order to slidably attach the first housing 222 mounting the solid-state imaging element 223 to the second housing 224, the solid-state imaging element 223 and the electronic circuit 226 are interconnected with a flexible flat cable so as to allow sliding of the first housing 222 for a predetermined distance.

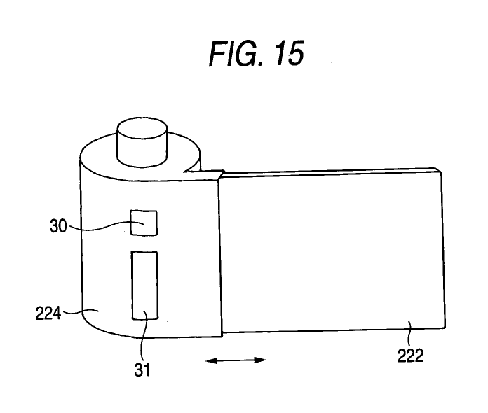

FIG. 4 and FIG. 15 each is a rear perspective view of the cartridge type solid-state image pickup apparatus 10 shown in FIG. 3 and FIGS. 14A and 14b. At predetermined positions on the rear of the cartridge type solid-state image pickup apparatus 10 are provided a pushbutton 30 for turning on the power supply and an antenna 31. The predetermined positions are preferably those facing a window for checking a film on the film camera 11 in case one is provided. This allows easy checkup from the window, of the pushbutton 30 illuminated when the button is held down.

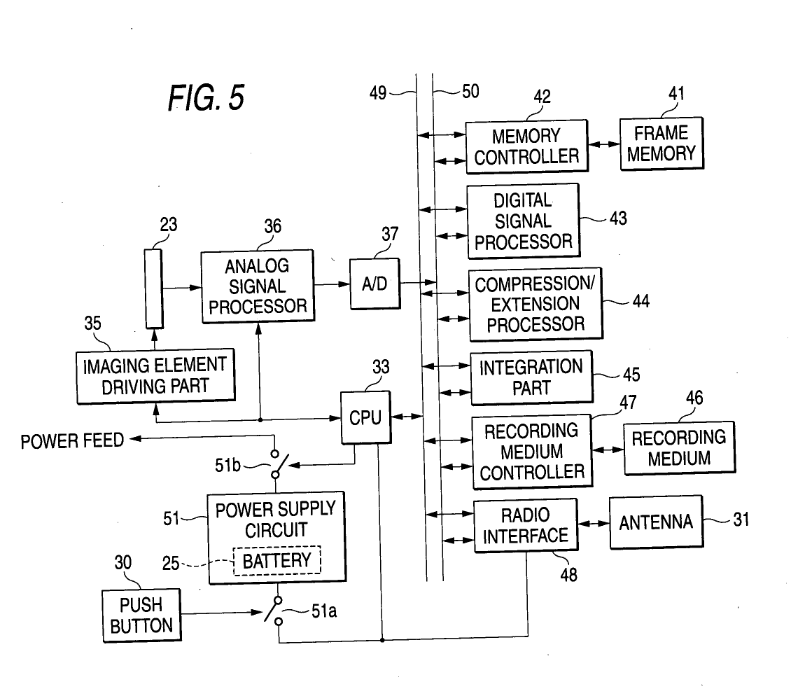

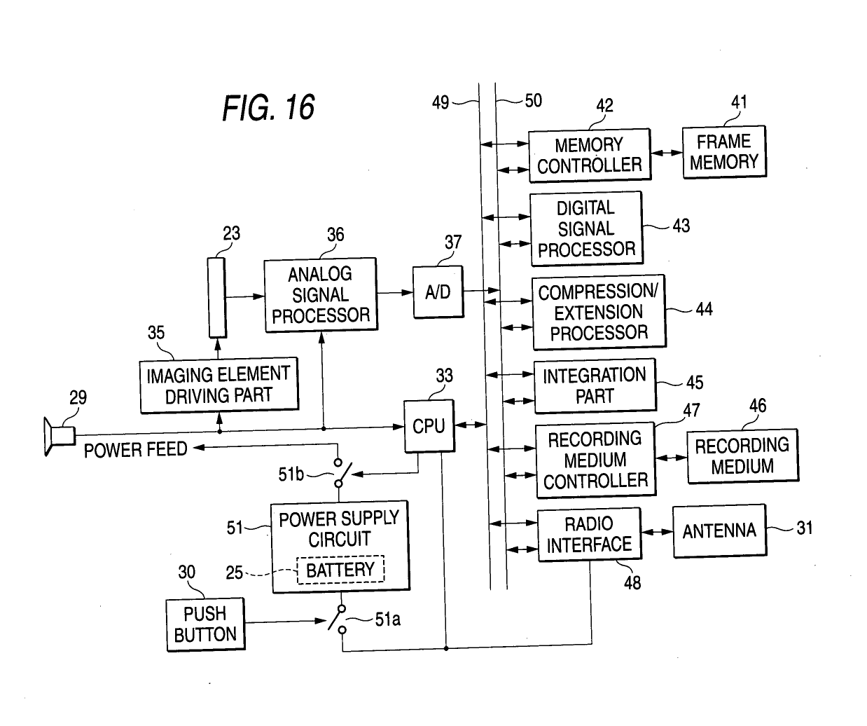

FIG. 5 is a functional block diagram of the cartridge type solid-state image pickup apparatus 10, 110 (including the functional configuration of the electronic circuit 26 in FIG. 3) shown in FIGS. 3 and 4. FIG. 16 is a functional block diagram of the cartridge type solid-state image pickup apparatus 210 (including the functional configuration of the electronic circuit 226 in FIG. 13) shown in FIGS. 14A and 14B and FIG. 15. The cartridge type solid-state image pickup apparatus 10, 110, 210 of the first to third embodiments comprises a CPU 33 for performing overall control of the cartridge type solid-state image pickup apparatus 10, 110, 210, an imaging element driving part 35 for controlling driving of the solid-state imaging element 23 based on a command from the CPU (controller) 33, an analog signal processor 36 for retrieving output data of the solid-state imaging element 23 to perform signal processing based on a command from the CPU 33, and an A/D converter 37 for converting the image data output from the analog signal processor 36 to digital data. In the third embodiment, a loudspeaker 29 is connected to the CPU 33.

The electric control system of the cartridge type solid-state image pickup apparatus 10, 110, 210 comprises a memory controller 42 connected to a frame memory 41, a digital signal processor 43 for retrieving digital image data output from the A/D converter 37 and performing image processing such as gamma correction and RGB/YC conversion, a compression/extension processor 44 for compressing a photographed image to a JPEG image and extending a compressed image, an integration part 45 for integrating photographed image data to adjust the white balance gain, a recording medium 46 for saving photographed image data such as JPEG image data, a recording medium controller 47 for controlling the recording medium 46, a radio interface 48 connected to the antenna 31 for performing radio communications with an external device, and a control bus 49 and a data bus 50 interconnecting these components.

The power supply circuit 51 of the cartridge type solid-state image pickup apparatus 10, 110, 210 has a battery power supply 25, 225 shown in FIGS. 3, 12 and 13 as a power source and feeds power to the CPU 33 and the radio interface 48 via an open/close switch 51a as well as feeds power to the processors of the cartridge type solid-state image pickup apparatus 10, 110, 210 except the CPU 33 and the radio interface 48.

The switch 51a is closed when the pushbutton switch 30 shown in FIG. 4 is pressed by the user thus feeding power to the CPU 33 and the radio interface 48. The switch 51b is under opening/closing control by a power input command from the CPU 33.

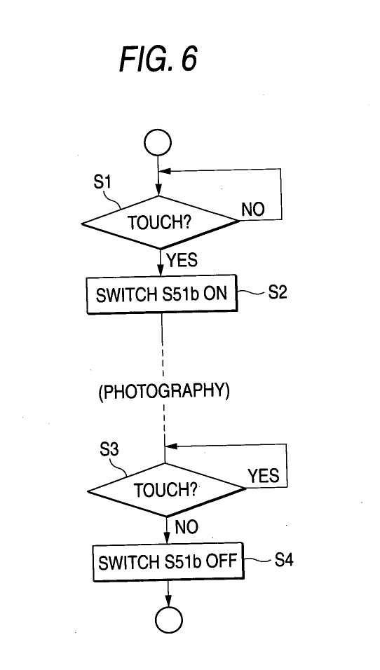

Next, operation of the cartridge type solid-state image pickup apparatus 10, 110, 210 will be described referring to the flowchart of power supply control procedure shown in FIG. 6.

The user presses the pushbutton 30 before attaching the cartridge type solid-state image pickup apparatus 10, 110, 210 to the film camera 11 in FIG. 1 in order to use the cartridge type solid-state image pickup apparatus 10 (in the third embodiment, the drawing distance of the first housing 222 from the second housing 224 is adjusted so as to align the light-receiving surface of the solid-state imaging element 223 with the image forming surface of the film camera 11.). This closes the open/close switch 51a in FIG. 5 and feeds power to the CPU 33 and the radio interface 48 alone. That is, the power supply control program shown in FIG. 6 is activated in a power save mode. The user fits the camera attachment 15 into the release button part 13 of the film camera 11.

When the user touches the button 16 in an attempt to photograph a digital image, the touch sensor senses this action and a radio signal indicating “touch” is sent from the antenna 19 of the attachment 15. The CPU 33 in FIG. 5 waits for reception of the “touch” signal in step S1 in FIG. 6. When the CPU 33 receives the “touch” signal from the antenna 31 via the radio interface 48, execution proceeds to step S2 where the switch 51b in FIG. 5 is closed. This enables all functions of the cartridge type solid-state image pickup apparatus 10.

The user then photographs a digital image same as photography on an ordinary film camera irrespective of the processing in FIG. 6. When the user half-depresses the button 16, the S1 switch of the release button 13 below the button 16 is turned on. This activates the auto focus function and exposure function of the film camera 11 to perform adjustment of a focus lens position and control of aperture quantity. A CPU (not shown) mounted on the film camera 11 separate from the CPU 33 determines the shutter speed.

When the user fully depresses the button 16, the S2 switch of the release button 13 below the button 16 is turned on and the shutter of the film camera 11 is released at the above shutter speed. In a camera mounting a focal-plane shutter, the front curtain and the rear curtain of the focal-plane shutter travel. In the case of a camera mounting a lens shutter, the lens shutter is opened/closed. It is possible to manually perform control of shutter speed and diaphragm aperture quantity as well as focus adjustment.

This forms a subject image on the light-receiving surface 23a of the solid-state imaging element 23. Data of the photographed image is read, same as an ordinary digital camera, and is stored on a recording medium 46.

The power supply control program shown in FIG. 6 waits for end of reception of a “touch” signal from the attachment 15 even during digital image photography (step S3). When the “touch” signal is no longer received, execution proceeds to step S4 to open the switch 51b. This activates the power save mode again, feeding power to the CPU 33 and the radio interface 48 alone, thus suppressing the power consumption of the battery 25.

While the switch 51b is immediately opened when the user has released his/her finger from the button 16 and the switch 51b is closed when the user has touched his/her finger on the button 16 in the embodiment shown in FIG. 6, a soft timer may be provided so as to keep the poser on for a predetermined duration, for example one minute from when the ser has released his/her finger from the button 16 in order prevent the power supply from being tuned on/off each time the user's finger touches/releases from the button 16.

As mentioned above, according to the first and second embodiments, battery power is input and a full drive mode is activated when the user initiates photography and a power save mode is activated when the user does not. This suppresses consumption of the battery power supply 25, allowing long-duration photography.

The cartridge type solid-state image pickup apparatus 10 according to the first embodiment uses a solid-state imaging element 23 having a light-receiving surface 23a extended in horizontal direction. The output data of the solid-state imaging element 23 contains a large quantity of invalid data as well as subject image data. Processing an image including the invalid data results in inefficient image processing. Position of the invalid data is not fixed but depends on the size of a film camera to which the cartridge type solid-state image pickup apparatus 10 is attached.

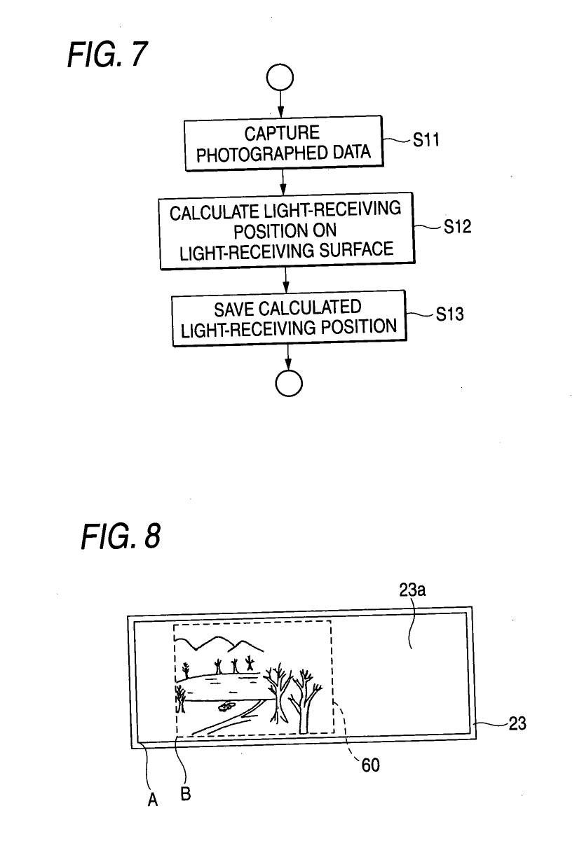

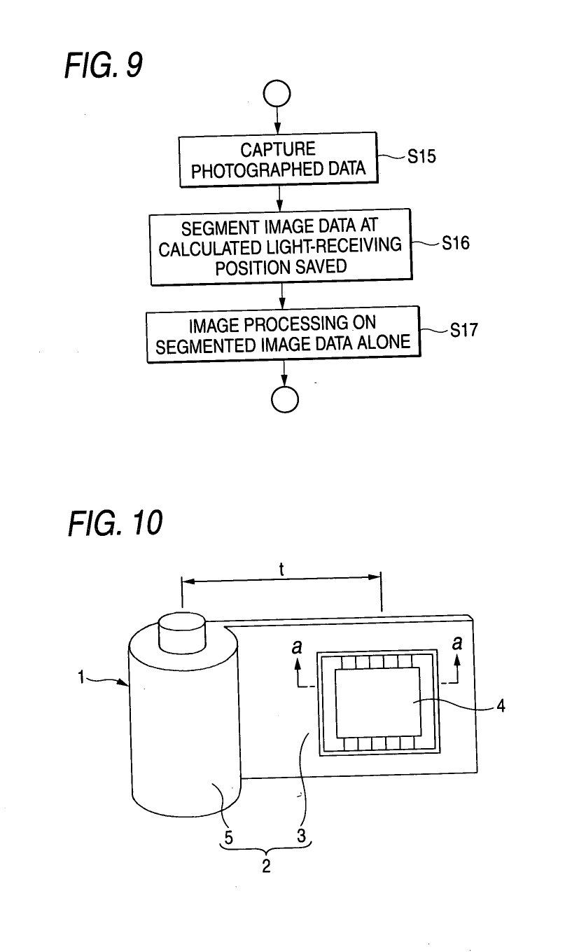

In the first embodiment, segmenting position calculation of photographed image data shown in FIG. 7 and photographed image data segmentation shown in FIG. 9 are executed based on a command from the CPU 33.

The segmenting position calculation of photographed image data shown in FIG. 7 is performed when a subject image is first photographed with the cartridge type solid-state image pickup apparatus 10 attached to the film camera 11. First, the subject is photographed. Then the image data output from the solid-state imaging element 23 is captured by the digital signal processor 43 via the analog signal processor 36 and the A/D converter 37 (step S11).

The image data captured into the digital signal processor 43 contains a large quantity of invalid data as mentioned above although the invalid data is positioned in an unexposed area. It is thus possible to discriminate the photographed image data from invalid data. As shown in FIG. 8, the image forming surface of a subject is segmented in a rectangular frame 60. The vertical length of the rectangular frame 60 should be approximately the same as the vertical length b shown in FIG. 3. The aspect ratio of the rectangular frame 60, that is, the aspect ratio of a photographed image is a predetermined ratio (aspect ratio of an ordinary photograph or aspect ratio of a photograph shot with an APS camera) so that the horizontal length is accordingly determined. With a predetermined position, for example, the lower left corner position of the rectangular frame 60 determined, the range of a photographed image is determined. In step S12, the lower left corner position of the rectangular frame 60 with respect to the origin A (lower left corner position in the illustrated example) of the light-receiving surface 23a of the solid-state imaging element 23 is calculated.

In step S13, B position data of the rectangular frame 60 obtained in step S12 is saved into the memory in the CPU 33. Processing in FIG. 7 may be repeated for a first plurality of photography practices to obtain and save into memory the position of the rectangular frame 60.

FIG. 9 is a flowchart of the photographed image data segmentation performed in the subsequent photography practices. Output data from the solid-state imaging element 23 is captured by the digital signal processor 43 via the analog signal processor 36 and the A/D converter 37 (step S15). Next, the CPU 33 informs the digital signal processor 43 of the B position data stored in memory to cause the digital signal processor 43 to segment the photographed image data in the rectangular frame 60 (step S16) The digital signal processor 43 performs image processing on the segmented photographed data alone (step S17). This boosts the processing.

Processing in FIG. 9 may be made by the analog signal processor 26 instead of the digital signal processor 43. When image data is read from the solid-state imaging element 23, only the photographed image data in the rectangular frame 60 may be read and invalid data discarded.

As mentioned above, the cartridge type solid-state image pickup apparatus 10 according to the first embodiment mounts a solid-state imaging element having a light-receiving surface horizontally extended when compared with the aspect ratio of an ordinary photograph. A single model of cartridge type solid-state image pickup apparatus 10 may support various types and sizes of film cameras. The user is no longer irritated by looking for cartridge type solid-state image pickup apparatus that fits the camera of his/her own. Manufacturers are not required to manufacture many types of cartridge type solid-state image pickup apparatus thus reducing the manufacturing cost.

The cartridge type solid-state image pickup apparatus 210 according to the third embodiment is so designed that the light-receiving surface 223a of the solid-state imaging element 223 is aligned with the image forming surface of the film camera 211 by adjustment of the drawing distance of the first housing 222 from the second housing 224. The first housing 222 is formed in support for a film so that a photographed image is not displaced in vertical direction. In case a positional shift results from the positional adjustment of the first housing 222, an image whose left side or right side is missing is photographed.

In the third embodiment, the CPU 33 determines, by using a position determination program, whether the position adjustment has resulted in a positional shift, and an alarm tone is issued from the loudspeaker 29 in the presence of a positional shift.

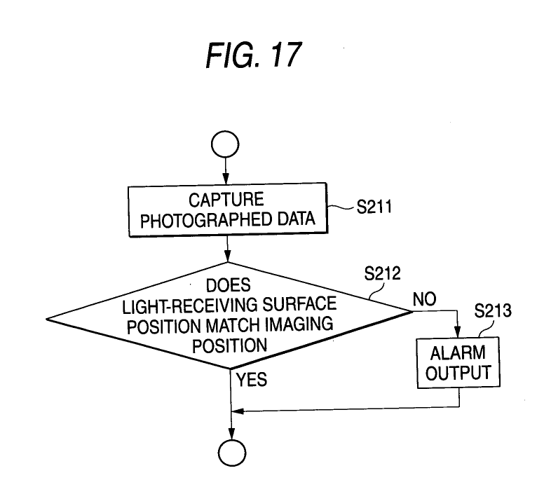

FIG. 17 is a flowchart showing the position determination processing performed under the control of the CPU 33. First, photographed image data output from the solid-state imaging element 223 is captured by the digital signal processor 43 via the analog signal processor 36 and the A/D converter 37 (step S211).

In case the image forming surface of the film camera 11 is aligned with the light-receiving surface 223a of the solid-state imaging element 223, image data captured into the digital signal processor 43 has a small quantity of invalid data. The invalid data refers to data output from pixels on the light-receiving surface 223a that do not receive light. When a positional shift occurs between the light-receiving surface 223a and the image forming surface, image data captured into the digital signal processor 43 has a larger quantity of invalid data on its right or left side. The digital signal processor 43 informs the CPU 33 of the pixel area where the invalid data is output and the quantity of invalid data. The CPU 33 thus determines whether the position of the light-receiving surface 223a matches the position of the image forming surface (step S212). In case a match is found, the processing is terminated without issuing an alarm.

Otherwise, execution proceeds from step S212 to step S213, where an alarm tone is output and the processing is terminated. The user thus knows the positional shift and is able to re-adjust the drawing distance of the first housing 222 from the second housing 224.

Accurate detection of the pixel area where invalid data is output and the invalid data quantity allows the CPU 33 to determine the direction and degree of the positional shift. For example, “two steps rightward” pr “one step leftward” may be instructed to the user as a voice alarm.

As mentioned above, the cartridge type solid-state image pickup apparatus 210 according to the third embodiment allows the position of the solid-state imaging element 223 to be adjusted. A single model of cartridge type solid-state image pickup apparatus 210 may support various types and sizes of film cameras. The user is no longer irritated by looking for cartridge type solid-state image pickup apparatus that fits the camera of his/her own. Manufacturers are not required to manufacture many types of cartridge type solid-state image pickup apparatus thus reducing the manufacturing cost.

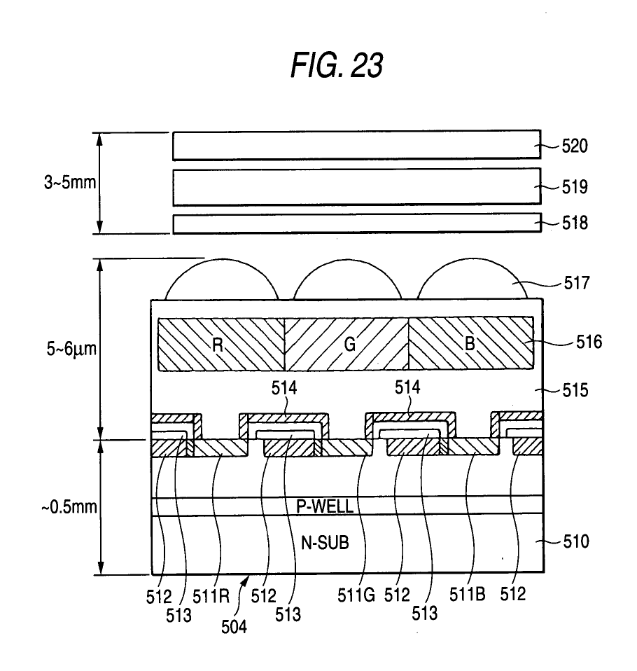

The low-profile photoelectric conversion film stacked color solid-state imaging element to be mounted on the cartridge type solid-state image pickup apparatus according to the fourth embodiment will be described. The configuration and operation of the cartridge type solid-state image pickup apparatus according to the fourth embodiment can be same as those of the image pickup apparatuses of the first to third embodiments. However, the color solid-state imaging element used in the fourth embodiment does not require the optical low-pass filter 519 shown in FIG. 23 in order to attain a low-profile design. That is, signal of three colors R, G, B are detected by one pixel. An IR cutoff filter is not provided separately from the solid-state imaging element but is integrally formed with the solid-state imaging element as a single layer of the solid-state imaging element. Configuration of the solid-state imaging element in the fourth embodiment will be detailed.

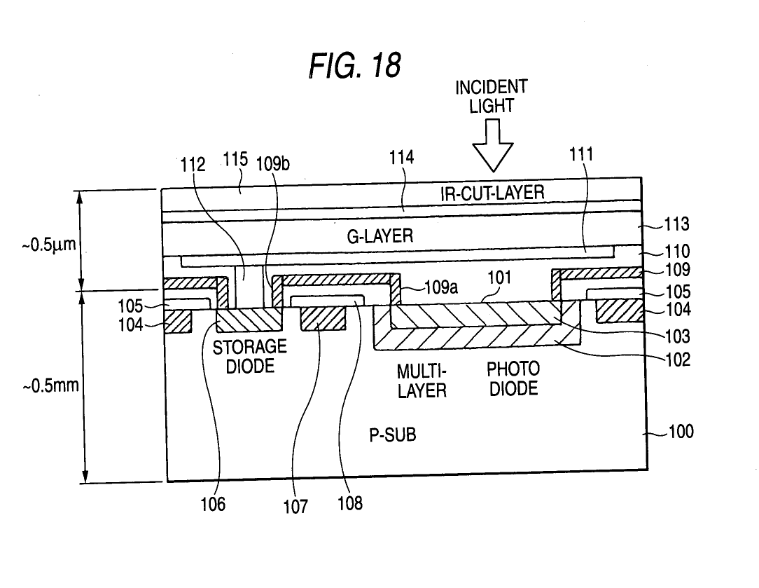

FIG. 18 is a schematic cross-sectional view of the unit cell of the photoelectric conversion film stacked color solid-state imaging element. The structure shown in FIG. 18 is two-dimensionally arranged both in vertical and horizontal direction to form a single solid-state imaging element.

In the deep part of the pixel position 101 of a p-type semiconductor substrate 100 is formed an n-type semiconductor layer 102, on which is formed a p-type semiconductor layer 103. As a result, pn junction formed between the semiconductor layer 103 and the semiconductor layer 102 constitutes a first photodiode and pn junction formed between the semiconductor layer 102 and the semiconductor layer 100 constitutes a second photodiode.

In this embodiment, for example, same as the solid-state imaging element shown in FIG. 5 of JP-A-2003-332551, the wavelength dependency of the absorption coefficient of silicon is used to detect, on the first photodiode in a shallow part, the signal charge generated in accordance with the quantity of incident light of short wavelength (blue light) and detect, on the second photodiode in a deep part, the signal charge generated in accordance with the quantity of incident light of long wavelength (red light).

On the surface of the semiconductor substrate 100 is formed an electric charge transfer path 104 so as to be adjacent to the pixel position 101, and a transfer electrode 105 is formed on the electric charge transfer path 104. Signal charges accumulated on the first and second photodiodes are read when a read pulse is applied to the transfer electrode 105 and separately transferred along the electric charge transfer path 104 when a transfer pulse is applied to the transfer electrode 105.

A signal charge accumulating area 106 for a green color (G) signal is formed in an appropriate position slightly apart from the pixel position 101 on the surface of the semiconductor substrate 100. An electric charge transfer path 107 is formed across the signal charge accumulating area 106 and the pixel position 101. A transfer electrode 108 is formed on the electric charge transfer path 107.

When a read pulse is applied to the transfer electrode 108, the signal charges accumulated in the signal charge accumulating area 106 are read into the electric charge transfer path 107. When a transfer pulse is applied to the transfer electrode 108, the signal charges are transferred along the electric charge transfer path 107.

An optical light-shielding film 109 is stacked on the surface of the semiconductor substrate 100. The light-shielding film 109 has an aperture 109a provided above the light-receiving surface of the first and second photodiodes and an aperture 109b provided above the signal charge accumulating area 106. The light-shielding film 109 is embedded in a transparent insulation layer 110 made of for example a silicon oxide film. On the insulation layer 110 is stacked a transparent pixel electrode film 111 separately from the pixel electrode film of an adjacent pixel. The pixel electrode film 111 is made of for example ITO. The pixel electrode film 111 and the signal charge accumulating area 106 are electrically interconnected via vertical wiring 112 such as a tungsten plug through the aperture 109b.

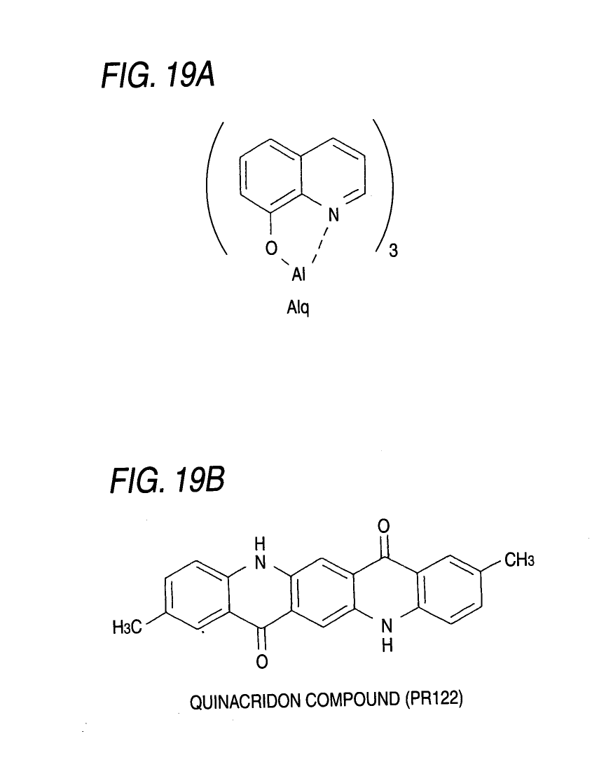

A single photoelectric conversion film 113 common to the pixels is stacked on the pixel electrode film 111. The photoelectric conversion film 113 is composed of a material that receives light in the intermediate wavelength region or green color (G) and generates optical discharges corresponding to the incident light quantity of green color. For example, an organic semiconductor, Alq or a quinacridon compound, or stacked nano-silicon layers may be used. Chemical formulas of Alq and quinacridon compound are shown in FIGS. 19A and 19B.

A single transparent common electrode film 114 made of ITO or the like common to the pixels is stacked on the photoelectric conversion film 113. On the transparent common electrode film 114 is stacked a filter layer 115. A protective layer may be stacked thereon.

In this embodiment, the filter layer 115 uses a material that at least absorbs or reflects ultraviolet rays of 400 nm or less and preferably shows an absorption ratio of 50 percent or more in the wavelength region of 400 nm or less. Further, the filter layer 115 uses a material that at least absorbs or reflects infrared rays of 700 nm or more and preferably shows an absorption ratio of 50 percent or more in the wavelength region of 700 nm or more.

The filter layer 115 that absorbs the ultraviolet rays and infrared rays may be formed using a known method. For example, a method is known where a moldant layer is provided on a substrate including a hydrophilic material such as gelatin, casein, glue or polyvinyl alcohol and the moldant layer is mixed or dyed with a dyestuff having a desired absorption wavelength. Further, a method is known where a precolored resin including a certain colorant dispersed in a transparent resin is used. For example, as described in JP-A-58-46325, JP-A-60-78401, JP-A-60-184202, JP-A-60-184203, JP-A-60-184204 and JP-A-60-184205, it is possible to use a precolored resin film including a mixture of a polyamino resin and a colorant. A colorant using a photosensitive polyimide resin is also used.

As described in JP-B-7-113685, it is possible to disperse a precolored material in an aromatic polyamide resin that has a photosensitive group in a molecule and that obtains a cured film at 200° C. or below. As described in JP-B-7-69486, it is possible to use a pigment for a dispersed precolored resin.

In this embodiment, a dielectric multilayer film may be used as the filter layer 115. The dielectric multilayer film is favorable since it has a sharp wavelength dependency of light transmission.

In case the filter layer 115 and the photoelectric conversion film 113 are formed separately by using an insulation layer in the manufacturing process, the filter layer 115 and the photoelectric conversion film 113 are preferably separated from an insulation layer. The insulation layer may be formed using a transparent insulation material such as glass, polyethylene, polyethylene telephthalate, polyethersulfone, or polypropylene. Silicon nitride and silicon oxide are preferably used. Silicon nitride formed via plasma CVD is favorable since it has a high density and transparency.

In case a protective layer or a sealing layer is provided to prevent contact with oxygen or water, a protective layer may be formed of an inorganic material film such as a diamond thin film, metal oxide or a metal nitride, a high polymer film such as a fluorine resin, poly-para-xylene, polyethylene, a silicon resin or a polysthylene resin, or a photo-setting resin. Glass, a non-gas-permeable plastic or a metal may be used to cover the pixel part and the pixel it self may be packaged by using an appropriate sealing resin. IN this case, it is possible to place a material with high water absorption in the packaging.

When the light from a subject is incident on the solid-state imaging element thus configured, infrared rays and ultraviolet rays are cutoff by the filter layer 115 and visible light is incident into the solid-state imaging element 43. The green color (G) light in the visible light is absorbed by the photoelectric conversion film 113 and optical charges corresponding to the incident quantity of green color (G) light are generated in the photoelectric conversion film 113. When a vias voltage is applied across the common electrode film 114 and the pixel electrode film 111, the optical charges promptly move to the signal charge accumulating area 106 via the vertical wiring 112.

The blue (B) light and the red (R) light of the incident light are incident on the aperture 109a in the light-shielding film 109 and enters the semiconductor substrate 100. The blue light with a shorter wavelength is absorbed mainly in the shallow part of the semiconductor substrate 100 to generate optical discharges. The optical discharges are accumulated in the first photodiode. The red light with a longer wavelength mainly reaches the deep part of the semiconductor substrate 100 to generate optical discharges. The optical discharges are accumulated in the second photodiode.

Signal charges corresponding to the green (G) light accumulated in the signal charge accumulating area 106, the signal charges corresponding to the blue (B) light accumulated in the first photodiode, and the signal charges corresponding to the red (R) light accumulated in the second photodiode are respectively read into the electric charge transfer path, transferred thereon and output from the solid-state imaging element.

In this way, the solid-state imaging element according to the fourth embodiment obtains three types of signal charges, R, G and B from a single pixel. This eliminates a color moiré in the absence of an optical low-pass filter. Thus, a lower-profile solid-state imaging element may be provided by the thickness of an optical low-pass filter. The filter layer 115 and the protective layer are integrally stacked so that it is not necessary to stacke an infrared cutoff layer and protective cover glass, and the thickness of the element design is further reduced.

The cartridge type solid-state image pickup apparatus mounting the solid-state imaging element has a thinner film part so that the cartridge type solid-state image pickup apparatus may be attached to a silver salt film camera including a focal-plane shutter. The light-receiving surface of the photoelectric conversion film 113 for receiving green light as a luminance signal is large, so that a microlens is not required. Further, shading is suppressed even after lens replacement and change in the exit pupil position.

While the signal read circuit is described by taking as an example the solid-state imaging element composed of an electric charge transfer path in the embodiment shown in FIG. 18, the signal read circuit may be composed of a MOS transistor, same as a CMOS image sensor.

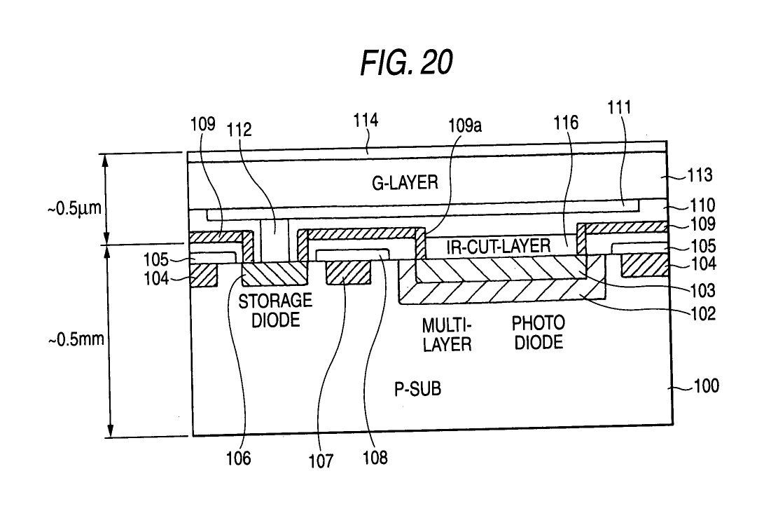

FIG. 20 is a schematic cross-sectional view of the unit cell of a photoelectric conversion film stacked color solid-state imaging element according to the fifth embodiment of the invention. Since the fifth embodiment is almost the same as the fourth embodiment, same components are given same signs. The corresponding description is omitted and only differences are discussed.

While the filter layer 115 is provided as an upper layer of a solid-state imaging element to cut off infrared rays in the fourth embodiment, an infrared cutoff filter 116 is provided in the aperture 109a in a light-shielding film 109 instead of the filter layer 115. Unlike the filter layer 115, the infrared cutoff filter 116 cuts off infrared rays alone.

Same as the fourth embodiment, this embodiment does not require an optical low-pass filter or an infrared cutoff filter. It is thus possible to provide a lower-profile solid-state imaging element.

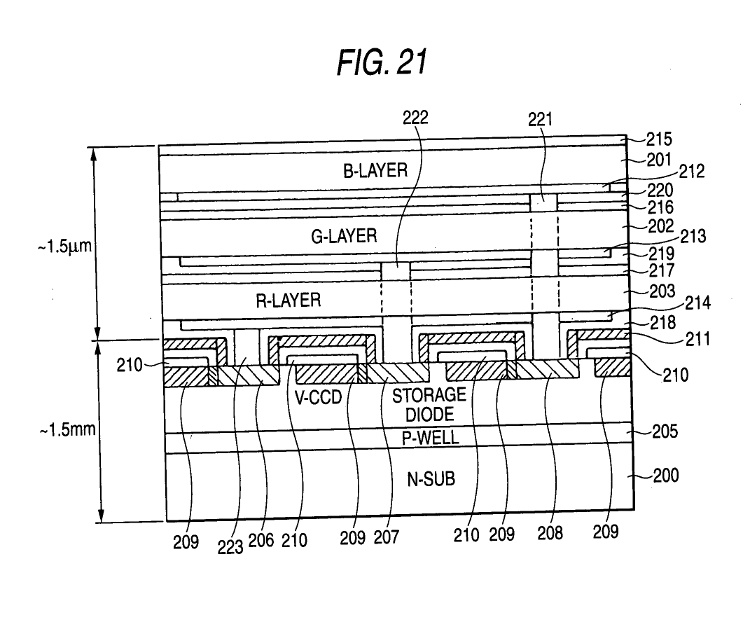

FIG. 21 is a schematic cross-sectional view of the unit cell of a photoelectric conversion film stacked color solid-state imaging element according to the sixth embodiment of the invention. In the fourth and fifth embodiments, a single layer of photoelectric conversion film is stacked on the semiconductor substrate 111 and two layers of photodiodes are further provided in order to detect three colors with a single pixel. In the sixth embodiment, a photoelectric conversion film 201 for detecting the blue color, a photoelectric conversion film 202 for detecting the green color and a photoelectric conversion film 203 for detecting the red color, total three films, are stacked on a semiconductor substrate 200.

The solid-state imaging element according to the sixth embodiment will be described. A p-well layer 205 formed on the surface of the n-type semiconductor substrate 200. On the n-type semiconductor substrate 200 are formed a red light electric charge accumulating part 206, a green light electric charge accumulating part 207 and a blue light electric charge accumulating part 208. An electric charge transfer path 209 is formed across the electric charge accumulating parts. A transfer electrode 210 is formed on each electric charge transfer path 209. A Light-shielding film 211 is stacked on each transfer electrode 21.

The photoelectric conversion films 201, 202 and 203 are respectively sandwiched by transparent pixel electrode films 212, 213, 214 segmented by pixel and transparent common electrode films 215, 216 and 217 in single-film configuration common to all pixels, and are then stacked via transparent insulation layers 218, 219 and 220. The pixel electrode film 212 and the blue light electric charge accumulating part 208 are interconnected via vertical wiring 221. The pixel electrode film 213 and the green light electric charge accumulating part 207 are interconnected via vertical wiring 222. The pixel electrode film 214 and the red light electric charge accumulating part 206 are interconnected via vertical wiring 223. Note that an ultraviolet cutoff filter layer is preferably provided on the common electrode film 215 in the uppermost position.

When light is incident on the solid-state imaging element according to the sixth embodiment, the blue light of the incident light is absorbed by the photoelectric conversion film 201 to generate optical charges, which are accumulated in the blue light electric charge accumulating part 208. The green light of the light that has passed through the photoelectric conversion film 201 is absorbed by the photoelectric conversion film 202 to generate optical charges, which are accumulated in the green light electric charge accumulating part 207. The red light of the light that has passed through the photoelectric conversion film 202 is absorbed by the photoelectric conversion film 203 to generate optical charges, which are accumulated in the red light electric charge accumulating part 206. Signal charges accumulated in the electric charge accumulating parts 206, 207, 208 are read into the electric charge transfer path 209 and transferred thereon, and is output from the solid-state imaging element.

Infrared rays includes in the incident light are not absorbed by any of the photoelectric conversion films 201, 202 and 203 but reaches the surface of the semiconductor substrate 100 and blocked by the light-shielding film 211.

The solid-state imaging element according to the sixth embodiment is thicker than that in the fourth and fifth embodiments since the former has a multilayer photoelectric conversion film. The increase in the thickness is on the order of 1 micrometer and smaller when compared with the thickness of the semiconductor substrate 200 being 0.5 mm. Thus, the same working effect is obtained from the third embodiment as the fourth and fifth embodiment.

While the signal read circuit using an electric charge transfer path is formed on the surface of a semiconductor substrate for the solid-state imaging element of the sixth embodiment, the signal circuit may be made of a MOS transistor.

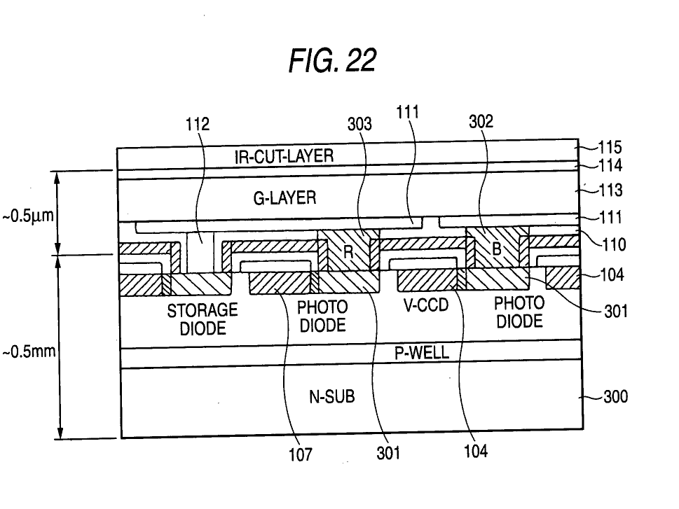

FIG. 22 is a schematic cross-sectional view of 1.5 unit cells of a photoelectric conversion film stacked color solid-state imaging element according to the seventh embodiment of the invention. In the seventh embodiment, unit cells for detecting green color (G) and blue color (B) and unit cells for detecting green color (G) and red color (R) are alternately provided in vertical and horizontal directions. The other components in FIG. 22 are almost the same as those in the fourth embodiment, same members are given same signs and the corresponding description is omitted.

In the fourth embodiment shown in FIG. 18, two layers of photodiode are provided on a semiconductor substrate to detect both blue color (B) and red color (R) separately by using the wavelength dependency of the absorption coefficient of silicon. In the seventh embodiment, a single layer of photodiode 310 is provided on the surface of the semiconductor substrate 300. For a certain unit cell, the blue color filter 302 is stacked on the photodiode 301 to detect a blue light signal while the red color filter 303 is stacked on the photodiode 301 of the adjacent unit cell to detect a red light signal.

The solid-state imaging element according to the seventh embodiment detects two colors by pixel. The remaining one color is obtained by interpolating the signals detected by surrounding pixels. Interpolation is made so that the sample point of a pixel generated by interpolation will be almost the same as that of the pixel corresponding to two colors. Thus a color moiré does not appear. As a result, an optical low-pass filter is not required and a lower-profile solid-state imaging element may be provides, same as the fourth to sixth embodiments.

The cartridge type solid-state image pickup apparatus according to this embodiment requires no modification to the film camera 11. When the film camera 11 is used as a silver salt film camera, the cartridge type solid-state image pickup apparatus 10 is simply detached from the camera 11 and a silver salt film is attached for use as a film camera.

The cartridge type solid-state image pickup apparatus according to this embodiment allows use of expensive, high-performance lenses and robust body of an existing film camera. In case the manufacturing technology of a solid-state imaging element is advanced to provide a solid-state imaging element with a higher pixel density, the user may enjoy, with reduced budget, the benefit of advances of technology simply by replacing the existing cartridge type solid-state image pickup apparatus with cartridge type solid-state image pickup apparatus mounting a new solid-state imaging element.

In the foregoing embodiment, photographed image data is stored on the recording medium 46 and the cartridge type solid-state image pickup apparatus 10 is taken out of the camera 11 and connected to a PC via a USB cable in order to read photographed image data to outside. For example, as described in JP-A-2003-234932, image data may be transmitted to an external portable terminal via the radio interface 48 to display photographed image data on the display screen of the portable terminal.

An additional configuration is possible where a command may be sent from the portable terminal to the CPU 33 via the radio interface 48 to perform various functions of an ordinary digital camera including switching of the sensitivity of the solid-state imaging element 23, switching of photography mode such as a still picture photography as well as white balance correction.

The cartridge type solid-state image pickup apparatus according to the invention may utilize the lens and the camera body of an exiting film camera without any modification thereto. A single model of cartridge type solid-state image pickup apparatus supports various types and sizes of film cameras. This provides a low-cost camera that replaces an existing digital camera with a lens.

The cartridge type solid-state image pickup apparatus according to the invention may utilize the lens and the camera body of an exiting film camera without any modification thereto. Suppressing battery power consumption and allowing long-duration photography, the cartridge type solid-state image pickup apparatus is useful as a camera that replaces an existing digital camera with a lens.

The entire disclosure of each and every foreign patent application from which the benefit of foreign priority has been claimed in the present application is incorporated herein by reference, as if fully set forth.

What is claimed is:

1. Cartridge type solid-state image pickup apparatus, which is used to photograph a digital image while it is attached to a film camera instead of a film, the apparatus comprising:
a housing having a shape of a cartridge from which the film is drawn by a predetermined length; and
a solid-state imaging element mounted on a part corresponding to the film,
wherein the solid-state imaging element has a light-receiving surface of an aspect ratio horizontally greater than that of a rectangular range to be photographed.

2. Cartridge type solid-state image pickup apparatus, which is used to photograph a digital image while it is attached to a film camera instead of a film, the apparatus comprising:
a housing having a shape of a cartridge from which the film is drawn by a predetermined length;
a solid-state imaging element mounted on a part corresponding to the film;
an electronic circuit that drives the solid-state imaging element and processes data read from the solid-state imaging element, the electronic circuit being in a part corresponding to the cartridge;
a battery power supply in the part corresponding to said cartridge;
a controller that operates on power from the battery power supply;
a switch section that feeds power of the battery power supply to the electronic circuit on receiving a power input command from the controller; and
a camera attachment configured separately from the housing and connected to the controller via radio waves, the camera attachment comprising: a button attached on a release button of the film camera and pressed integrally with the release button; a sensor that senses a touch on the button; and a radio originating section that performs radio transmission of a detection signal to the controller when the touch is sensed so as to output the power input command to the switch section.

3. Cartridge type solid-state image pickup apparatus, which is used to photograph a digital image while it is attached to a film camera instead of a film, the apparatus comprising:
a housing having a shape of a cartridge from which the film is drawn by a predetermined length; and
a solid-state imaging element mounted on a part corresponding to the film, wherein the housing comprises:
a first housing that has a plate shape corresponding to a shape of the film and mounts the solid-state imaging element; and
a second housing that has a cylinder shape corresponding to the cartridge to which the first housing is attached in a fashion that the first housing can be inserted therein and can be drawn therefrom for a predetermined distance.

4. Cartridge type solid-state image pickup apparatus, which is used to photograph a digital image while it is attached to a film camera instead of a film, the apparatus comprising:
a housing having a shape of a cartridge from which a film is drawn by a predetermined length;
a solid-state imaging element mounted on a part corresponding to the film; and
an electronic circuit that drives the solid-state imaging element and processes data read from the solid-state imaging element, the electronic circuit being in a part corresponding to the cartridge;
a battery power supply being in a part corresponding to the cartridge;
wherein the solid-state imaging element is a photoelectric conversion film stacked color solid-state imaging element comprising: a semiconductor substrate; and at least one layer of photoelectric conversion film for performing photoelectric conversion of green light on or above the semiconductor substrate.

5. The cartridge type solid-state image pickup apparatus according to claim 4,
wherein the photoelectric conversion film stacked color solid-state imaging element further comprises: a photoelectric conversion film for performing photoelectric conversion of red light; and a photoelectric conversion film for performing photoelectric conversion of blue light, on or above the semiconductor substrate.

6. The cartridge type solid-state image pickup apparatus according to claim 4,
wherein the photoelectric conversion film stacked color solid-state imaging element further comprises: a first photodiode for receiving and performing photoelectric conversion of blue light; and a second photodiode for receiving and performing photoelectric conversion of red light in the semiconductor substrate.

7. The cartridge type solid-state image pickup apparatus according to claim 6,
wherein the first photodiode and the second photodiode are stacked in a depth direction of the semiconductor substrate.

8. The cartridge type solid-state image pickup apparatus according to claim 4,
wherein an infrared light cutoff filter layer is integrally formed on the photoelectric conversion film stacked color solid-state imaging element.
